(19) United States
(12) Patent Application Publication
(10) Pub. No.: US 2026/0122672 A1
(43) Pub. Date: Apr. 30, 2026

(54) COMMUNICATION METHOD AND COMMUNICATION APPARATUS

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 18/578,352

(22) PCT Filed: Jul. 13, 2021
(86) PCT No.: PCT/CN2021/105966

§ 371 Date: Jan. 11, 2024

(51) Int. Cl. H04W 74/0808

(52) U.S. Cl. CPC H04W 74/0808

(57) ABSTRACT

A communication method, apparatus and computer readable storage medium for improving spectrum utilization in a wireless communication system. The spectrum utilization is improved by: determining a data frame under a first link, performing channel sensing under the first link and a second link, updating a network allocation vector timer (NAV timer) under the links according to sensing results under the first link and the second link, and transmitting the data frame according to the NAV timer.

### CROSS REFERENCE TO RELATED APPLICATION

The present application is a U.S. National Stage of International Application No. PCT/CN2021/105966, filed on Jul. 13, 2021, the entire content of which is incorporated herein by reference for all purposes.

### BACKGROUND

A current research scope of Wi-Fi technology is: 320 MHz bandwidth transmission, aggregation and collaboration of a plurality of frequency bands, and the like. It is expected to increase the rate and throughput by at least four times compared to existing standards. Its main application scenarios are video transmission, augmented reality (AR), virtual reality (VR), and like.

The aggregation and collaboration of the plurality of frequency bands refers to simultaneous communication between devices in the frequency bands of 2.4 GHz, 5.8 GHz, and 6-7 GHz. For the simultaneous communication between the devices in the plurality of frequency bands, a new media access control (MAC) mechanism needs to be defined for management. In addition, it is further expected that the aggregation and collaboration of the plurality of frequency bands can support low-latency transmission.

At present, a maximum bandwidth supported in a current aggregation and collaboration technology of the plurality of frequency bands is 320 MHz (160 MHz+160 MHz), and in addition, 240 MHz (160 MHz+80 MHz) and other bandwidths supported by existing standards may further be supported.

Multi-link communication will be supported in the currently researched Wi-Fi technology. For example, an access point (AP) and a station (STA) included in a current wireless communication system may be a multi-link device (MLD), that is, a function of transmitting and/or receiving under multiple links is supported. Thus, there may be multiple links between AP MLD and non-AP STA MLD.

### SUMMARY

A communication method is provided according to an example of the disclosure. The communication method includes: sensing a first link and a second link, where the first link and the second link belong to a non simultaneously transmit and receive (NSTR) link pair, the first link and the second link are sensed under the present link, and received PPDU is inter-PPDU or intra-PPDU; and determining, on the basis of results of judging from the link, whether to update a network allocation vector timer (NAV timer) and whether to transmit data.

A wireless communication method, performed by an AP that supports multi-link communication, and includes: generating a wireless frame and broadcasting SR parameter information under each link to a station (STA) under a link through the wireless frame, wherein the parameter information is configured to indicate the STA to execute spatial reuse.

A communication apparatus is provided according to an example of the disclosure. The communication apparatus is applied to a station that supports multi-link communication, and includes: a transceiving module, configured to execute receiving and transmitting operations; and a processing module, configured to: determine a data frame under a first link, perform channel sensing under the first link and a second link, update a network allocation vector timer (NAV timer) under the link according to sensing results under the first link and the second link, and transmit the data frame according to the network allocation vector timer (NAV timer).

An electronic device is provided according to an example of the disclosure. The electronic device includes a memory, a processor, and a computer program stored on the memory and capable of being run on the processor. When executing the computer program, the processor implements the method described above.

A non-transitory computer-readable storage medium is provided according to an example of the disclosure. The computer readable storage medium stores a computer program. The computer program, when executed by a processor, implements the method as described above.

### BRIEF DESCRIPTION OF THE DRAWINGS

By referring to accompanying drawings to describe examples of the disclosure in detail, the above and other features of the examples of the disclosure will become more apparent, in which:

FIG. 1 is an example diagram illustrating a wireless communication scenario.

FIG. 2 is an example diagram illustrating multi-link communication.

FIG. 3 is a flow diagram illustrating a communication method according to an example.

FIG. 4 is a flow diagram illustrating a communication method according to an example.

FIG. 5 is a block diagram illustrating a communication apparatus according to an example.

### DETAILED DESCRIPTION

The following description with reference to the accompanying drawings, is provided to assist in a comprehensive understanding of the various examples of the disclosure limited by the attached claims and their equivalents. The various examples of the disclosure include various specific details, but these specific details are merely considered as examples. In addition, for clarity and conciseness, descriptions of well-known technologies, functions, and constructions may be omitted.

Terms and words used in the disclosure are not limited to written meanings, but are merely used by an inventor, so as to clearly and consistently understand the disclosure. Thus, for those skilled in the art, the description of various examples of the disclosure is provided merely for illustrative purposes and not for limiting purposes.

It needs to be understood that unless the context clearly indicates, otherwise, singular forms “one”, “a”, “said” and “the” used here may also include plural forms. It needs to be further understood that the wording “include” used in the disclosure refers to existence of the described feature, integer, step, operation, element and/or component, but not excluding existence or adding one or more other features, integers, steps, operations, elements, components and/or their combinations.

It will be understood that although the terms “first,” “second,” and the like may be used here to describe various elements, these elements should not be limited by these terms. These terms are merely used to distinguish one element from another. Hence, a first element discussed below may be referred to as a second element without departing from the teaching of the examples.

It needs to be understood that when the element is referred to as “connected” or “coupled” to the other element, it may be directly connected or coupled to other elements, or there may also be an intermediate element. In addition, “link” or “coupling” used here may include wireless link or wireless coupling. A term “and/or” or the expression “at least one/at least one of . . . ” used here includes any and all combinations of one or more related listed items.

Unless otherwise defined, all the terms (including technical terms and scientific terms) used here have the same meanings generally understood by those ordinarily skilled in the art to which the disclosure belongs.

The disclosure relates to the field of wireless communication, in particular, to a communication method and a communication apparatus.

A current research scope of Wi-Fi technology is: 320 MHz bandwidth transmission, aggregation and collaboration of a plurality of frequency bands, and the like. It is expected to increase the rate and throughput by at least four times compared to existing standards. Its main application scenarios are video transmission, augmented reality (AR), virtual reality (VR), and the like.

The aggregation and collaboration of the plurality of frequency bands refers to simultaneous communication between devices in the frequency bands of 2.4 GHz, 5.8 GHz, and 6-7 GHz. For the simultaneous communication between the devices in the plurality of frequency bands, a new media access control (MAC) mechanism needs to be defined for management. In addition, it is further expected that the aggregation and collaboration of the plurality of frequency bands can support low-latency transmission.

At present, a maximum bandwidth supported in a current aggregation and collaboration technology of the plurality of frequency bands is 320 MHz (160 MHz+160 MHz), and in addition, 240 MHz (160 MHz+80 MHz) and other bandwidths supported by existing standards may further be supported.

Multi-link communication will be supported in the currently researched Wi-Fi technology. For example, an access point (AP) and a station (STA) included in a current wireless communication system may be a multi-link device (MLD), that is, a function of transmitting and/or receiving under multiple links is supported. Thus, there may be multiple links between AP MLD and non-AP STA MLD.

In order to improve the throughput of dense environments, a spatial reuse (SR) mechanism is introduced, such as packet detect based spatial reuse (PD-based SR) or parameterized spatial reuse (PSR-based SR).

Due to the use of a multi-AP coordination method and an SR mechanism in R2 to improve regional throughput in 802.11be, the existing SR mechanism is merely a multi-AP coordination mechanism (SRG: spatial reuse group) mechanism that is not suitable for supporting multi-link communication in 802.11be, especially communication when operating in an NSTR mode.

All aspects of the disclosure will at least solve the above problems and/or defects. Various examples of the disclosure provide the following technical solutions.

A communication method is provided according to an example of the disclosure. The communication method includes: sensing a first link and a second link, where the first link and the second link belong to a non simultaneously transmit and receive (NSTR) link pair, the first link and the second link are sensed under the present link, and received PPDU is inter-PPDU or intra-PPDU; and determining, on the basis of results of judging from the link, whether to update a network allocation vector timer (NAV timer) and whether to transmit data.

A communication apparatus is provided according to an example of the disclosure. The communication apparatus is applied to a station that supports multi-link communication, and includes: a transceiving module, configured to execute receiving and transmitting operations; and a processing module, configured to: determine a data frame under a first link, perform channel sensing under the first link and a second link, update a network allocation vector timer (NAV timer) under the link according to sensing results under the first link and the second link, and transmit the data frame according to the network allocation vector timer (NAV timer).

An electronic device is provided according to an example of the disclosure. The electronic device includes a memory, a processor, and a computer program stored on the memory and capable of being run on the processor. The processor, when executing the computer program, implements the method as described above.

A non-transitory computer-readable storage medium is provided according to an example of the disclosure. The computer readable storage medium stores a computer program. The computer program, when executed by a processor, implements the method as described above.

The technical solution provided in examples of the disclosure can adapt to 802.11be and support the multiple-communication link under an existing SR mechanism in an NSTR mode, thus improving regional throughput, and increasing the rate of spectrum utilization.

FIG. 1 is an example diagram illustrating a wireless communication scenario.

A basic service set (BSS) may be composed of an AP and one or more stations (STAs) that communicate with the AP. One basic service set may be connected to a distribution system (DS) through its AP, or may be accessed to another basic service set, forming an extended service set (ESS).

In a wireless communication environment, the plurality of basic service sets (BSSs) may usually exist, such as BSS 1 and BSS2 shown in FIG. 1. Each BSS may include one access point and one or more stations. In FIG. 1, for the sake of description simplicity, an example of each BSS, including one access point and one station is shown. However, it needs to be understood that the number of the basic service sets and the number of the access points and the stations in each basic service set shown in FIG. 1 are merely illustrative, and the example of the disclosure is not limited to this.

AP is a wireless switch used for a wireless network and is also a core of the wireless network. An AP device may be used as a wireless base station, mainly as a bridge to connect the wireless network with a wired network. By utilizing this access point AP, wired and wireless networks may be integrated.

The AP may include software applications and/or circuits to enable other types of nodes in the wireless network to communicate with the exterior and interior of the wireless network through the AP. In some examples, as an example, the AP may be a terminal device or network device equipped with a wireless fidelity (Wi-Fi) chip.

As an example, the station may include, but is not limited to: a cellular phone, a smart phone, a wearable device, a computer, a personal digital assistant (PDA), a personal communication system (PCS) device, a personal information manager (PIM), a personal navigation device (PND), a global positioning system, a multimedia device, an Internet of Things (IoT) device, and the like.

In the example of the disclosure, the AP and the STA in each BSS may support a multi-link device, and for example, may be represented as AP MLD and non-AP STA MLD, respectively. As an example merely, the AP MLD may represent the access point that supports a multi-link communication function, while non-AP STA MLD may represent a station that supports the multi-link communication function. In this case, the AP and the STA in the BSS1 and the BSS2 shown in FIG. 1 may be represented as the AP MLD and the non-AP STA MLD, respectively, which can communicate under multiple links. In addition, the AP MLD in BSS1 may also communicate with the AP MLD or the non-AP MLD in the BSS2 under multiple links. For ease of description, an example of one AP MLD and one non-AP MLD is shown in each BSS shown in FIG. 1. However, the example of the disclosure is not limited to this. For example, each BSS may include different numbers of AP MLD and non-AP MLD depending on an actual communication environment.

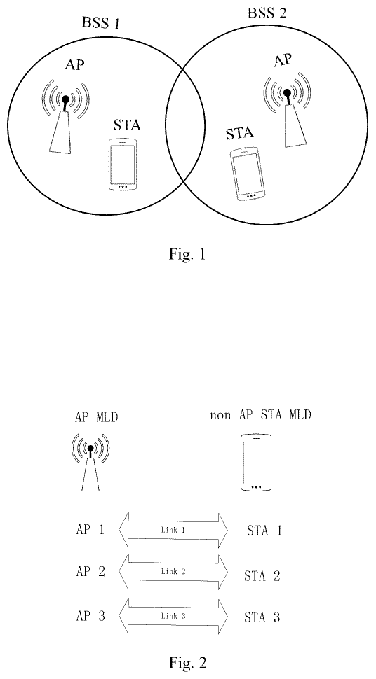

FIG. 2 shows a specific example of communication between AP MLD and non-AP MLD under multiple links (e.g., Link 1 to Link 3). Referring to FIG. 2, the AP MLD may work under three links, such as AP1, AP2, and AP3 shown in FIG. 2, while the non-AP MLD may also work under three links, such as STA1, STA2, and STA3 shown in FIG. 2. In the example in FIG. 2, it is assumed that AP1 and STA1 communicate through the corresponding first Link 1. Similarly, AP2 and AP3 communicate with STA2 and STA3 through a second Link 2 and a third Link 3, respectively. In addition, Link 1 to Link 3 may be multiple links at different frequencies, such as links at 2.4 GHz, 5 GHZ, and 6 GHZ, or several links with the same or different bandwidths at 2.4 GHz, 5 GHZ, and 6 GHz. In addition, there may be a plurality of channels under each link. However, it needs to be understood that the communication scenario shown in FIG. 2 is merely illustrative, and the concept of this disclosure is not limited to this. For example, the AP MLD may be connected to the plurality of non-AP MLDs, or at each link, the AP may communicate with the plurality of other types of stations.

In response to determining that the access points in the plurality of basic service sets are densely arranged in a wireless communication environment, there may be overlapping coverage areas between the basic service sets, such as an overlapping basic service set (OBSS), which may lead to communication interference. Thus, a spatial reuse (SR) technology is introduced to improve communication efficiency and the rate of spectrum utilization.

In the multi-link communication, there may be two types of non-AP MLDs, namely non-AP MLD with simultaneously transmit and receive (STR) (called “non-AP MLD with an STR capability”) and non AP MLD with non simultaneously transmit and receive (NSTR) (called “non-AP MLD with an NSTR capability”). For the non-AP MLD with the STR capability, transmitting and receiving may be performed under multiple links at the same time. For the non-AP MLD with the NSTR capability, transmitting and receiving cannot be performed under multiple links at the same time. Specifically, for the non-AP MLD with the NSTR capability, there is a non simultaneously transmit and receive pair (i.e., an NSTR pair) in the multiple links supported by the non-AP MLD. In at least two links of the NSTR pair, when receiving (or transmitting) is performed under one link belonging to the NSTR pair, transmitting needs not to be performed in any link belonging to the NSTR pair. In addition, if the non-AP MLD with the NSTR capability needs to be transmitted simultaneously under at least two links, it needs to meet the following conditions: the at least two links are idle at the same time and the transmission, under the at least two links, reaches a receiver simultaneously. As a non-limiting example, in response to determining that the non-AP MLD in FIG. 2 supports the NSTR capability and Link 1 to Link 3 form the NSTR pair, then when transmitting and/or receiving under Link 1, receiving and/or transmitting cannot be performed under Link 2 and Link 3 simultaneously. At present, there is a lack of a multi-link communication solution that applies an SR mechanism to non-AP MLD including the NSTR capability.

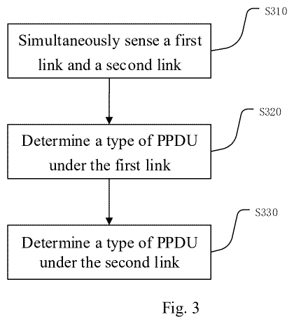

FIG. 3 is a flow diagram illustrating a communication method according to an example. The communication method shown in FIG. 3 may be performed by a station that supports multi-link communication (i.e. non-AP MLD).

According to an example of the disclosure, the non-AP MLD supports NSTR capability and includes an NSTR pair. The NSTR pair may be at least two of the multiple links supported by the non-AP MLD for multi-link communication.

In the disclosure, SR parameter information received by a station STA and transmitted by an AP may be SR parameter information transmitted by either an associated AP or a non-associated AP. In response to determining that the AP is the non-associated AP, the station STA reports SR transmitted by the AP to the associated AP.

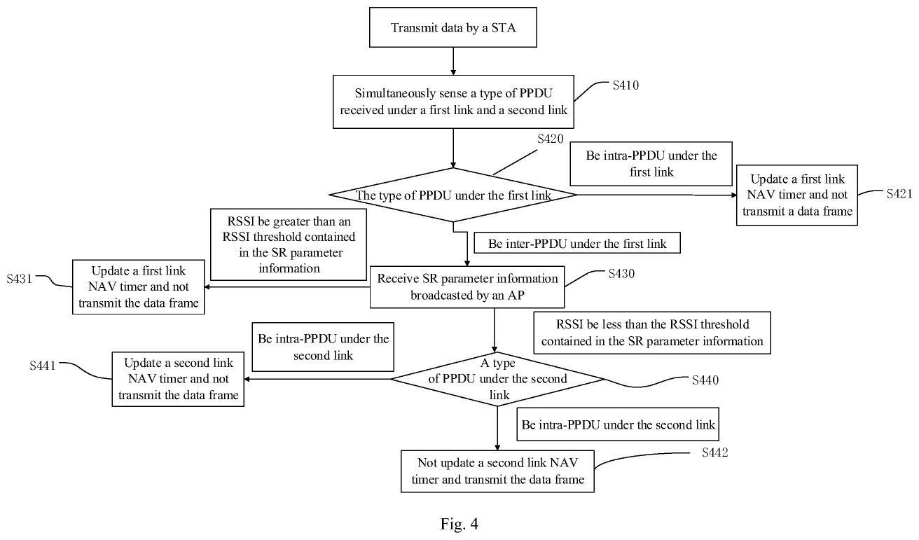

Referring to FIG. 3, in step 310, channels under a first link and a second link may be sensed. According to the example, the first link and the second link belong to an NSTR link pair, where the first link may be a first link (also known as “present link”) in the NSTR pair that will be used for data transmitting, and the second link may be other links in the NSTR pair besides the first link. According to the example of the disclosure, sensing of a channel under the first link and the second link may be performed based on the first link and the second link. In response to determining that the first link and the second link are mutually NSTR (non simultaneously Tx&Rx), then sensing needs to be continued under the first link, and sensing needs to be performed under the second link and a network allocation vector timer NAV under the corresponding link is updated. In response to determining that the network allocation vector timer is recorded as 0, it indicates that the device can access the channel. It will be described in detail later with reference to FIG. 4.

In step 320, whether reception under the first link is inter-PPDU or intra-PPDU is judged. based on sensing of the first link In step 330, based on the results of judgment in step 320, whether to judge the reception under the first link being inter-PPDU or intra-PPDU is determined. For example, in a case of determining that in step 320 that the reception under the first link is the intra-PPDU, regardless of the type of PPDU received under the second link (whether the second link is the inter-PPDU or the intra-PPDU), it is determined to update the first NAV time and not to transmit data under the first link. For example, when it is determined in step 320 that the reception under the first link is the inter-PPDU, whether the reception under the second link is the inter-PPDU or the intra-PPDU may be further judged based on the sensing of the second link, and then whether to update the second link NAV timer and whether to perform data transmitting under the first link are determined according to the judgment results. The judgment of the inter-PPDU or the intra-PPDU is determined based on a BSS color value of a station allocated by an AP. In case that the BSS color value parsed in a physical header of a PPDU frame is the same, it is judged as the intra-PPDU, or in case that the allocated BSS color value belongs to the same space division reuse group, it may also be judged as the intra-PPDU; and in case that judged as the inter-PPDU, it does not belong to any of the aforementioned situations. A detailed description will be made below with reference to FIG. 4.

In addition, due to the need for communication between the AP and the associated STA, a TXOP duration under each link may be broadcasted to facilitate the determination of channel busyness during channel sensing in the later stage. For example, when a first channel is detected to be in an idle state and a second channel is detected to be in a busy state, TXOP of the second channel may be detected. After the TXOP is invalid, the sensing of the first channel and the second channel may be performed again.

Moreover, during TXOP duration broadcasting, information on whether to use an NSTR mode or an STR mode for communication may further be carried on the corresponding frame. For example, NSTR bitmap information may be used for identification. As needed, the AP may further carry SR parameter information from other APs and TXOP information from STR/NSTR. An SR parameter value may further include a maximum value/minimum value of interference of an NSTR link pair. For example, link 1 and link 2 are mutually NSTR link pairs, the maximum value of interference may be carried in the SR parameter.

Referring to FIG. 4, in response to determining that one STA of non-AP STA MLD is going to transmit data under one link (first link), the operation may be performed according to step 410 to step 440.

In step 410, the type of PPDU received under the first link and the second link may be sensed. For example, in case that the reception under the first link is the inter-physical layer protocol data unit (PPDU), the network allocation vector (NAV) timer under the present link is updated according to the spatial reuse (SR) parameter message broadcasted by the AP. The SR parameter information here refers to SR parameter information broadcasted by the AP to each link in a beacon frame under one link.

According to the example of the disclosure, the type of PPDUs received under the first link and the second link is sensed simultaneously, and whether to change the corresponding NAV timer and whether to transmit a data frame are determined according to the type of the PPDUs received under the first link and the second link. The type of the PPDU includes inter-PPDU and intra-PPDU. In this example, it needs to judge the type of the PPDU received under the second link in a case that the PPDU under the first link is inter-PPDU.

In step 420, the type of the PPDU under the first link is judged. The judgment may be based on sensing results in step 410. For example, whether the type of the PPDU under the first link is the intra-PPDU may be judged based on the type of the PPDU under the first link determined in step 410, so as to determine whether to perform transmitting in the channel of the first link after the judgment is completed. In a case of determining that the type of the PPDU under the first link is the intra-PPDU, there is no need to judge the type of the PPDU under the second link, a first link NAR timer is directly updated, and the data frame is not transmitted under the first link.

In one example of the disclosure, in step 420, whether the type of the PPDU under the first link is the inter-PPDU is judged. The judgment may be performed based on sensing results in step 410. For example, whether the type of the PPDU under the first link is the inter-PPDU may be judged based on the type of the PPDU under the first link determined in step 410, so as to determine whether to transmit the data frame in the channel of the first link after the judgment is completed and whether to update the first link NAV timer.

In step S430, it is determined that the type of the PPDU under the first link is the inter-PPDU, and the first link NAV timer under the link is updated according to the SR parameter information broadcasted by the AP.

The specific SR parameters broadcasted by the AP are shown in Table 1.

TABLE 1
Spatial reuse parameter setting unit format

| | | | | | SRG | SRG | | |
|---|---|---|---|---|---|---|---|---|
| | | | | Non SRG | OBSS PD | OBSS PD | SRG | SRG |
| | | | | OBSS PD | minimum | maximum | BSS | space |
| Unit | | Unit ID | SR | maximum | offset | offset | color | BSSID |
| ID | Length | extension | control | offset | value | value | bitmap | bitmap |
| 1 | 1 | 1 | 1 | 0 or 1 | 0 or 1 | 0 or 1 | 0 or 8 | 0 or 8 |

A format of an SR control domain is shown in Table 2.

TABLE 2
Format of the SR control domain

| | Not | | | | |
|---|---|---|---|---|---|
| Not | allow non | Non SRG | SRG | Allow HESIGA_{—} | |
| allow | SRG | offset | informa- | spatial reuse | Reserved |
| PSR | OBSS PD | value | tion | value 15 | bit |
| 1 | 1 | 1 | 1 | 1 | 3 |

In one example of the disclosure, as shown S421 in FIG. 4, in a case of determining that the PPDU under the first link is the inter-PPDU, the SR parameter information broadcasted by the AP is received. In response to determining that Received Signal Strength Indicator (RSSI) received by the inter-PPDU received under the first link is greater than an RSSI threshold contained in the SR parameter information, there is no need to determine the type of the PPDU under the second link, the first link NAV timer is updated, and the data frame is not transmitted.

In one example of the disclosure, in a case of determining that the PPDU under the first link is the inter-PPDU, the SR parameter information broadcasted by the AP is received. In response to determining that the RSSI received by the inter-PPDU received under the first link is less than the RSSI threshold contained in the SR parameter information, the first link NAV timer is not updated. But whether to transmit the data frame depends on the determination of the type of the PPDU under the second link. Similarly, the type of the PPDU under the second link may also be the inter-PPDU or the intra-PPDU. According to the type of the PPDU under the second link, whether to transmit the data frame in the channel of the first link after the judgment is completed and whether to update the second link NAV timer are determined.

In one example of the disclosure, as shown S441 in FIG. 4, in a case of determining that t the PPDU under the first link is the inter-PPDU, the SR parameter information broadcasted by the AP is received. In response to determining that the RSSI received by the inter-PPDU received under the first link is less than the RSSI threshold contained in the SR parameter information, the first link NAV timer is not updated, and meanwhile, the type of the PPDU under the second link is determined. In response to determining that the type of the PPDU under the second link is the intra-PPDU, the second link NAV timer is updated, and the data frame is not transmitted.

In another example of the disclosure, as shown in S442 FIG. 4, in a case of determining that the PPDU under the first link is the inter-PPDU, the SR parameter information broadcasted by the AP is received. In response to determining that the RSSI received by the inter-PPDU received under the first link is less than the RSSI threshold contained in the SR parameter information, the first link NAV timer is not updated, and meanwhile, the type of the PPDU under the second link is determined. In response to determining that the type of the PPDU under the second link is the inter-PPDU, the second link NAV timer is not updated, and meanwhile, the data frame is transmitted.

According to the communication method of the example of the disclosure, spatial reuse in multi-link communication is achieved through the link for transmitting the data in the NSTR link pair, the type of the PPDU under multiple links, and the received RSSI threshold contained in the SR parameter information transmitted by the AP, thus increasing the rate of spectrum utilization and improving the system throughput.

In one example of the disclosure, the station STA receives the SR parameter information transmitted by the AP before sensing the first link and the second link, the parameter information is non SRG information, and the parameter information is used by the station to determine whether to update the corresponding NAV timer.

The disclosure further discloses a wireless communication method, performed by an AP that supports multi-link communication. The AP generates a wireless frame and broadcasts SR parameter information under a link to a station STA under a link through the wireless frame, where the parameter information is used to indicate the STA to execute spatial reuse information. For example, the SR parameter information contains an RSSI threshold, and whether to update a first link NAV timer by comparing an RSSI value received by inter-PPDU received under a first link with the RSSI threshold contained in the SR parameter information. The AP broadcasts the SR parameter information under each link in a beacon frame under one link, and may carry identification of a link ID.

In one example of the disclosure, in a case of determining that PPDU under the first link is inter-PPDU, the SR parameter information broadcasted by the AP is received. In response to determining that RSSI received by the inter-PPDU received under a first link is greater than the RSSI threshold contained in the SR parameter information, there is also no need to determine a type of the PPDU under a second link, the first link NAV timer is updated, and a data frame is not transmitted.

In one example of the disclosure, in a case of determining that the PPDU under the first link is the inter-PPDU, the SR parameter information broadcasted by the AP is received. In response to determining that the RSSI received by the inter-PPDU received under the first link is less than the RSSI threshold contained in the SR parameter information, the first link NAV timer is not updated, and meanwhile, the type of the PPDU under the second link is determined. In response to determining that the type of the PPDU under the second link is intra-PPDU, the second link NAV timer is updated, and the data frame is not transmitted.

In another example of the disclosure, in a case of determining that the PPDU under the first link is the inter-PPDU, the SR parameter information broadcasted by the AP is received. In response to determining that the RSSI received by the inter-PPDU received under the first link is less than the RSSI threshold contained in the SR parameter information, the first link NAV timer is not updated, and meanwhile, the type of the PPDU under the second link is determined. In response to determining that the type of the PPDU under the second link is the inter-PPDU, the second link NAV timer is not updated, and meanwhile, the data frame is transmitted.

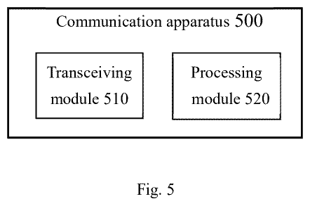

FIG. 5 is a block diagram illustrating a communication apparatus according to an example. The communication apparatus 500 may include a transceiving module 510 and a processing module 520. The communication apparatus shown in FIG. 5 may be applied to a station (non-AP STA MLD) that supports multi-link communication.

According to the example of the disclosure, the transceiving module 510 may be configured to: execute receiving and transmitting operations; and the processing module 520 may be configured to: determine a data frame under a first link, perform channel sensing under the first link and a second link, update an NAV timer under the link according to sensing results under the first link and the second link, and transmit the data frame according to the NAV timer.

According to the example of the disclosure, the transceiving module 510 is further configured to: receive, by a station STA, the SR parameter information transmitted by the AP before sensing the first link and the second link, the parameter information being non SRG information, where the parameter information is used by the station to determine whether to update the NAV timer.

According to the example of the disclosure, the processing module 520 is further configured to: update, in response to determining that reception under the first link is inter-PPDU, a first link NAV timer under a present link according to the SR parameter information broadcasted by the AP.

According to the example of the disclosure, the processing module 520 is further configured to: update, in response to determining that RSSI received by the inter-PPDU received under the first link is greater than an RSSI threshold contained in the SR parameter information, the first link NAV timer and not transmit the data frame.

According to the example of the disclosure, the processing module 520 is further configured to: not update, in response to determining that RSSI received by the inter-PPDU received under the first link is less than an RSSI threshold contained in the SR parameter information, the first link NAV timer.

According to the example of the disclosure, the processing module 520 is further configured to: update, in response to determining to be sensed as intra-PPDU of the second link under the second link, a second link NAV timer and not transmit the data frame.

According to the example of the disclosure, the processing module 520 is further configured to: not update, in response to determining to be sensed as inter-PPDU of the second link under the second link, the second link NAV timer and transmit the data frame.

According to the example of the disclosure, the processing module 520 is further configured to: update, in response to determining that reception under the first link is intra-PPDU, the first link NAV timer and not transmit the data frame.

It will be understood that the communication apparatus 500 shown in FIG. 5 is merely illustrative, and the examples of the disclosure are not limited to this. For example, the communication apparatus 500 may further include other modules, such as a memory module. In addition, various modules in the communication apparatus 500 may be combined into more complex modules or divided into more individual modules.

The communication method described in FIG. 3 and FIG. 4 and the communication apparatus described in FIG. 5 can apply the spatial reuse mechanism in the multi-link device to improve spectrum utilization efficiency and system throughput.

Based on the same principle as the method provided in the examples of the disclosure, an example of the disclosure further provides an electronic device. The electronic device includes a processor and a memory; where, the memory stores a machine readable instruction (also known as a “computer program”); and the processor is configured to execute the machine readable instruction to implement the method described with reference to FIG. 3 and FIG. 4.

An example of the disclosure further provides a computer readable storage medium, storing a computer program. The computer program, when executed by a processor, implements the method described with reference to FIG. 3 and FIG. 4.

In the examples, the processor may be configured to implement or execute various example logical blocks, modules, and circuits described in conjunction with the content of the disclosure, for example, a central processing unit (CPU), a general-purpose processor, a digital signal processor (DSP), an application specific integrated circuit (ASIC), a field programmable gate array (FPGA) or other programmable logic devices, transistor logic devices, hardware components or any their combinations. The processor may also be a combination implementing a computing function, for example, a combination containing one or more microprocessors, a combination of DSP and the microprocessor, etc.

In the examples, the memory may be a read only memory (ROM), a random access memory (RAM), an electrically erasable programmable read only memory (EEPROM), a compact disc read only memory (CD-ROM) or other compact disc storage, optical disc storage (including a compression optical disc, a laser optical disc, an optical disc, a digital universal optical, a blu-ray disc and the like) and disk storage mediums or other magnetic storage devices, or any other mediums capable of being used for storing program codes with instruction or data structure forms and capable of being accessed by a computer, but is not limited to this.

It needs to be understood that although all the steps in the flow diagrams of the drawings are sequentially shown according to arrow indication, these steps are not necessarily executed sequentially according to an order indicated by arrows. Unless expressly stated here, execution of these steps has no strict order limitation, and these steps may be executed in other orders. In addition, at least a part of steps in the flow diagrams of the drawings may include a plurality of substeps or a plurality of stages, these substeps or stages are not necessarily executed and completed at the same moment, and may be executed at the different moments. The execution orders are not necessarily execution in sequence, and these substeps or stages may be alternately executed with other steps or at least part of the substeps or stages of other steps.

Although the disclosure has been illustrated and described with reference to certain examples of the disclosure, those skilled in the art will understand that various changes in form and details may be made without departing from the scope of the disclosure. Thus, the scope of the disclosure should not be limited to examples, but should be limited by the attached claims and their equivalents.

1. A wireless communication method, performed by a station (STA) that supports multiple links, and comprising:
determining a data frame under a first link, performing channel sensing under the first link and a second link, updating a network allocation vector timer (NAV timer) under the links according to sensing results under the first link and the second link, and transmitting the data frame according to the NAV timer.

2. The method according to claim 1, further comprising:
updating, in response to determining that reception under the first link is an inter-protocol data unit (PPDU), a first link network allocation vector timer (NAV timer) under a present link according to a Spatial Reuse (SR) parameter information broadcasted by an Access Point (AP).

3. The method according to claim 2, further comprising:
updating, in response to determining that a Received Signal Strength Indicator (RSSI) received by the inter-PPDU received under the first link is greater than an RSSI threshold contained in the SR parameter information, the first link network allocation vector timer (NAV timer) and not transmitting the data frame.

4. The method according to claim 2, further comprising:
not updating, in response to determining that a Received Signal Strength Indicator (RSSI) received by the inter-PPDU received under the first link is less than an RSSI threshold contained in the SR parameter information, the first link network allocation vector timer (NAV timer).

5. The method according to claim 4, further comprising:
updating, in response to determining to be sensed as a intra-PPDU of the second link under the second link, a second link network allocation vector timer (NAV timer) and not transmitting the data frame.

6. The method according to claim 4, further comprising:
not updating, in response to determining to be sensed as an inter-PPDU of the second link under the second link, a second link network allocation vector timer (NAV timer) and transmitting the data frame.

7. The method according to claim 1, further comprising:
updating, in response to determining that reception under the first link is an intra-PPDU, a first link network allocation vector timer (NAV timer) and not transmitting the data frame.

8. The method according to claim 1, further comprising:
receiving, by the STA, a Spatial reuse (SR) parameter information transmitted by an Access Point (AP) before sensing the first link and the second link, the parameter information being non spatial reuse group (non-SRG) information, wherein the parameter information is used by the station to determine whether to update the network allocation vector timer (NAV timer).

9. The method according to claim 1, further comprising:
further receiving, by the STA, Spatial reuse (SR) parameters from other APs and reporting the same to an associated AP, wherein, the other APs are non-associated APs.

10. A wireless communication method, performed by an AP that supports multi-link communication, and comprising:
generating a wireless frame and broadcasting SR parameter information under each link to a station (STA) under a link through the wireless frame, wherein the SR parameter information is configured to indicate the STA to execute spatial reuse.

11. The method according to claim 10, further comprising:
the SR parameter information carrying identification of a link ID.

12.-13. (canceled)

14. An electronic device, comprising
a memory,
one or more processors that are communicatively coupled to the memory, and
a non-transitory computer program stored on the memory, the non-transitory computer program when executed by the one or more processors causes the one or more processors to collectively execute a method comprising:
determining a data frame under a first link,
performing channel sensing under the first link and a second link,
updating a network allocation vector timer (NAV timer) under the first link and the second links according to sensing results under the first link and the second link, and
transmitting the data frame according to the NAV timer.

15. The electronic device according to claim 14, wherein the method further comprises:
updating, in response to determining that reception under the first link is an inter-protocol data unit (PPDU), a first link network allocation vector timer (NAV timer) under a present link according to a Spatial Reuse (SR) parameter information broadcasted by an Access Point (AP).

16. The electronic device according to claim 15, wherein the method further comprises:
updating, in response to determining that a Received Signal Strength Indicator (RSSI) received by the inter-PPDU received under the first link is greater than an RSSI threshold contained in the SR parameter information, the first link network allocation vector timer (NAV timer) and not transmitting the data frame.

17. The electronic device according to claim 15, wherein the method further comprises:
not updating, in response to determining that a Received Signal Strength Indicator (RSSI) received by the inter-PPDU received under the first link is less than an RSSI threshold contained in the SR parameter information, the first link network allocation vector timer (NAV timer).

18. The electronic device according to claim 17, wherein the method further comprises:
updating, in response to determining to be sensed as an intra-PPDU of the second link under the second link, a second link network allocation vector timer (NAV timer) and not transmitting the data frame.

19. The electronic device according to claim 17, wherein the method further comprises:
not updating, in response to determining to be sensed as an inter-PPDU of the second link under the second link, a second link network allocation vector timer (NAV timer) and transmitting the data frame.

20. The electronic device according to claim 14, wherein the method further comprises:
updating, in response to determining that reception under the first link is an intra-PPDU, a first link network allocation vector timer (NAV timer) and not transmitting the data frame.

21. The electronic device according to claim 14, wherein the method further comprises:
receiving, by a station (STA), a Spatial Reuse (SR) parameter information transmitted by an Access Point (AP) before sensing the first link and the second link, the parameter information being non SRG information, wherein the parameter information is used by the station to determine whether to update the network allocation vector timer (NAV timer).

22. An electronic device, comprising:
a memory,
one or more processors that are communicatively coupled to the memory, and
a non-transitory computer program stored on the memory, the non-transitory computer program when executed by the one or more processors cause the one or more processors to collectively execute the method according to claim 10.
